(19) United States
(12) Patent Application Publication
(10) Pub. No.: US 2024/0267156 A1
(43) Pub. Date: Aug. 8, 2024

(54) Devices and Methods for AP Cooperation in a Wireless Communication Network

(71) Applicant: Huawei Technologies Co., Ltd., Shenzhen (CN)

(72) Inventors: Oren Hencinski, Hod Hasharon (IL); Ohad Klausner, Hod Hasharon (IL); Yotam Katzman, Hod Hasharon (IL); Doron Ezri, Hod Hasharon (IL); Chun Pan, Nanjing (CN)

(21) Appl. No.: 18/638,193

(22) Filed: Apr. 17, 2024

Related U.S. Application Data
(63) Continuation of application No. PCT/CN2022/099699, filed on Jun. 20, 2022.

(51) Int. Cl. H04L 1/1607; H04W 84/12

(52) U.S. Cl. CPC H04L 1/1621; H04W 84/12

(57) ABSTRACT

A first access point (AP) in a wireless local area network (WLAN) is configured to communicate with one or more non-AP stations associated with the first AP and at least one second AP. The first AP includes a communication interface configured to receive, from the one or more non-AP stations, a first subset of uplink packets transmitted by the one or more non-AP stations to the first AP and receive, from the at least one second AP, a second subset of the uplink packets transmitted by the one or more non-AP stations to the first AP. Moreover, the first AP comprises a processing circuitry configured to determine the uplink packets based on the first subset and the second subset.

### CROSS-REFERENCE TO RELATED APPLICATIONS

This is a continuation of International Patent Application No. PCT/CN2022/099699 filed on Jun. 20, 2022, which is hereby incorporated by reference in its entirety.

### TECHNICAL FIELD

The present disclosure relates to wireless communications. In particular, the present disclosure relates to devices and methods for access point (AP) cooperation in a wireless communication network.

### BACKGROUND

Wireless communication networks, such as the Institute of Electrical and Electronics Engineers (IEEE) 802.11 based wireless local area networks (WLANs), have become popular at an unprecedented rate. Besides conventional Internet applications such as email, file transfer, and web browsing, wireless communication networks, such as IEEE 802.11 based WLANs, also support real time applications, such as enterprise applications in the industry safety domain, increasing the demand for low latency connections.

WLANs deployed in the enterprise domains often comprise a plurality of access points, APs, wherein due to the limited unlicensed spectrum (both at 5 gigahertz (GHz) and 2.4 GHz) it is often necessary to allocate the same channel to more than one AP. The amendment IEEE 802.11ax introduces orthogonal frequency-division multiple access (OFDMA) transmission which may lead to long multi-user (MU) transmission in the order of 5 milliseconds (ms) and longer. Thus, once a MU OFDAM downlink transmission is started in an overlapping basic service set (OBSS) this generates a huge delay for other APs operating on the same channel resulting in a large latency and/or jitter, which may be disadvantageous for numerous applications, such as enterprise applications in the industry safety domain.

### SUMMARY

It is an objective of the present disclosure to provide devices and methods for an improved AP cooperation in a wireless communication network allowing for low latency communication and/or low jitter communication.

The foregoing and other objectives are achieved by the subject matter of the independent claims. Further implementation forms are apparent from the dependent claims, the description and the figures.

According to a first aspect an AP for a WLAN is provided, in particular an IEEE 802.11 based WLAN (or WI FI network). The AP is configured to communicate with one or more non-AP stations associated with the AP and to communicate with at least one further OBSS AP associated with one or more further non-AP stations. The AP comprises a communication interface configured to receive from the one or more non-AP stations a subset of a plurality of uplink packets transmitted by the one or more non-AP stations to the AP and to receive from the further OBSS AP a further subset of the plurality of uplink packets transmitted by the one or more non-AP stations to the AP, which were intended for the AP, but received by the further OBSS AP.

Moreover, the AP comprises a processing circuitry configured to determine the plurality of uplink packets transmitted by the one or more non-AP stations based on the subset and the further subset of the plurality of uplink packets transmitted by the one or more non-AP stations. The subset and the further subset of the plurality of uplink packets transmitted by the one or more non-AP stations and received by the AP and the further OBSS AP may be complementary or at least partially overlapping, i.e. some of the uplink packets transmitted by the one or more non-AP stations may be part of both the subset of uplink packets received by the AP and the further subset of uplink packets received by the further OBSS AP. The subset and the further subset of uplink packets received by the AP and the further OBSS AP may depend, for instance, on the interference and/or the signal-to-noise ratio (SNR) at the AP and the further OBSS AP, respectively.

Thus, an improved AP for a wireless communication network is provided allowing for low latency and/or low jitter communication. Embodiments disclosed herein allow improving the time-sharing interference mitigation capabilities, in particular in enterprise/industry deployments with a plurality of densely spaced APs. By better mitigating the WI-FI time sharing OBSS interference, embodiments disclosed herein allow reducing the latency to the order of a few milliseconds, which is essential for numerous applications, for instance, applications in the industry safety domain.

In a further possible implementation form, the communication interface is configured to receive the further subset of the plurality of uplink packets via a wired and/or wireless connection from the further OBSS AP.

In a further possible implementation form, the communication interface is further configured, in response to receiving the further subset of the plurality of uplink packets from the further OBSS AP, to send a block acknowledgment (BA) message to the one or more non-AP stations.

In a further possible implementation form, each of the plurality of uplink packets comprises and/or is associated with a packet sequence identifier and/or a traffic, wherein the processing circuitry is further configured to arrange the subset and the further subset of the plurality of uplink packets based on the packet sequence identifier and/or the traffic identifier of each uplink packet.

In a further possible implementation form, the communication interface is further configured to transmit a grouping request to the further OBSS AP and to receive from the further OBSS AP, in response to the grouping request, a grouping acknowledgement message. The grouping request may trigger the further OBSS AP to start listening to the uplink traffic of the AP.

In a further possible implementation form, the grouping acknowledgement message transmitted by the further OBSS AP to the AP comprises an address of each of the one or more non-AP stations, for instance, a media access control (MAC) address, a receiving received signal strength indicator (RSSI) and/or a receiving SNR of each of the one or more non-AP stations at the further OBSS AP.

According to a second aspect a method of operating an AP of a WLAN is provided, in particular an IEEE 802.11 based WLAN. The AP is configured to communicate with one or more non-AP stations associated with the AP and to communicate with at least one further OBSS AP, which may be associated with one or more further non-AP stations. The method according to the second aspect comprises the steps of receiving from the one or more non-AP stations a subset of a plurality of uplink packets transmitted by the one or more non-AP stations to the AP, receiving from the further OBSS AP a further subset of the plurality of uplink packets transmitted by the one or more non-AP stations to the AP, and determining the plurality of uplink packets transmitted by the one or more non-AP stations based on the subset and the further subset of the plurality of uplink packets transmitted by the one or more non-AP stations.

The method according to the second aspect of the present disclosure can be performed by the AP according to the first aspect of the present disclosure. Thus, further features of the method according to the second aspect of the present disclosure, result directly from the functionality of the AP according to the first aspect of the present disclosure as well as its different implementation forms described above and below.

According to a third aspect a backend network entity for a WLAN is provided, wherein the WLAN comprises an AP associated with one or more non-AP stations and at least one further OBSS AP, which may be associated with one or more further non-AP stations. The network entity comprises a communication interface configured to receive from the AP a subset of a plurality of uplink packets transmitted by the one or more non-AP stations to the AP and to receive from the further OBSS AP a further subset of the plurality of uplink packets transmitted by the one or more non-AP stations to the AP. Moreover, the network entity comprises a processing circuitry configured to determine the plurality of uplink packets transmitted by the one or more non-AP stations based on the subset and the further subset of the plurality of uplink packets transmitted by the one or more non-AP stations.

In a further possible implementation form, the communication interface is configured to receive the subset of the plurality of uplink packets and/or the further subset of the plurality of uplink packets via a wired and/or wireless connection with the AP and the further OBSS AP.

In a further possible implementation form, each of the plurality of uplink packets comprises and/or is associated with a packet sequence identifier and/or a traffic identifier, wherein the processing circuitry is further configured to arrange the subset and the further subset of the plurality of uplink packets based on the packet sequence identifier and/or the traffic identifier of each uplink packet.

In a further possible implementation form, the communication interface is further configured to receive a grouping acknowledgement message from the AP indicating a grouping of the AP with the further OBSS AP.

In a further possible implementation form, the grouping acknowledgement message comprises an address, for instance, a MAC address of each of the one or more non-AP stations, a receiving RSSI and/or a receiving SNR of each of the one or more non-AP stations at the further OBSS AP.

According to a fourth aspect a WLAN is provided. The WLAN comprises an AP associated with one or more non-AP stations, wherein the AP is configured to receive a subset of a plurality of uplink packets transmitted by the one or more non-AP stations to the AP. Moreover, the WLAN comprises at least one further OBSS AP, which may be associated with one or more further non-AP stations, wherein the at least one further OBSS AP is configured to receive a further subset of the plurality of uplink packets transmitted by the one or more non-AP stations to the AP. The WLAN further comprises a backend network entity according to the third aspect. The at least one further OBSS AP is configured to transmit a report message to the AP indicative of the further subset of the plurality of uplink packets received by the at least one further OBSS AP. The AP is configured to transmit a BA message to the one or more non-AP stations based on the subset of a plurality of uplink packets received by the AP and the report message from the at least one further OBSS AP.

According to a fifth aspect a method of operating a backend network entity of a WLAN is provided. The WLAN comprises an AP associated with one or more non-AP stations and at least one further OBSS AP, which may be associated with one or more further non-AP stations. The method comprises the steps of receiving from the AP a subset of a plurality of uplink packets transmitted by the one or more non-AP stations to the AP, receiving from the further OBSS AP a further subset of the plurality of uplink packets transmitted by the one or more non-AP stations to the AP, and determining the plurality of uplink packets transmitted by the one or more non-AP stations based on the subset and the further subset of the plurality of uplink packets transmitted by the one or more non-AP stations.

The method according to the fifth aspect of the present disclosure can be performed by the network entity according to the fourth aspect of the present disclosure. Thus, further features of the method according to the fifth aspect of the present disclosure result directly from the functionality of the network entity according to the fourth aspect of the present disclosure as well as its different implementation forms described above and below.

According to a sixth aspect a computer program product is provided, comprising program code which causes a computer or a processor to perform the method according to the second aspect or the method according to the fifth aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings.

FIG. 1A shows a schematic diagram illustrating an exemplary wireless communication network, including an AP and a further AP according to an embodiment;

FIG. 1B shows a schematic diagram illustrating an exemplary wireless communication network, including an AP, a further AP and a backend network entity according to a further embodiment;

FIG. 2, FIG. 3, FIG. 4, and FIG. 5 show timing diagrams illustrating the interaction between an AP, a further AP and a network entity in a wireless communication network according to an embodiment for different communication scenarios;

FIG. 6 shows a signalling diagram illustrating the interaction between an AP and a further AP for starting cooperation in a wireless communication network according to an embodiment;

FIG. 7 shows a flow diagram illustrating processing steps implemented by an AP according to an embodiment; and FIG. 8 shows a flow diagram illustrating processing steps implemented by a backend network entity according to an embodiment.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless noted otherwise.

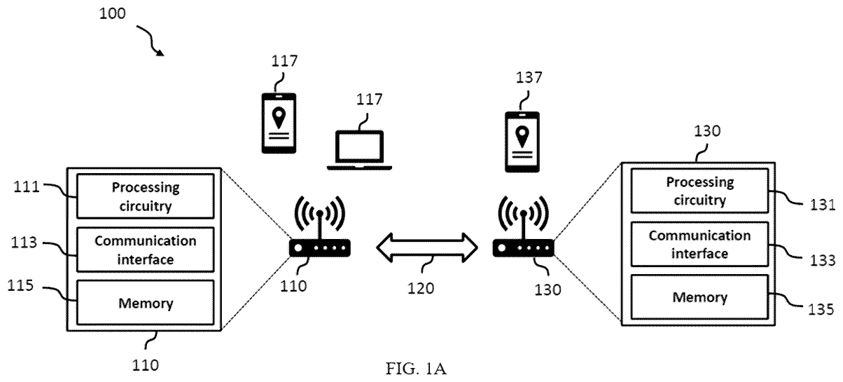

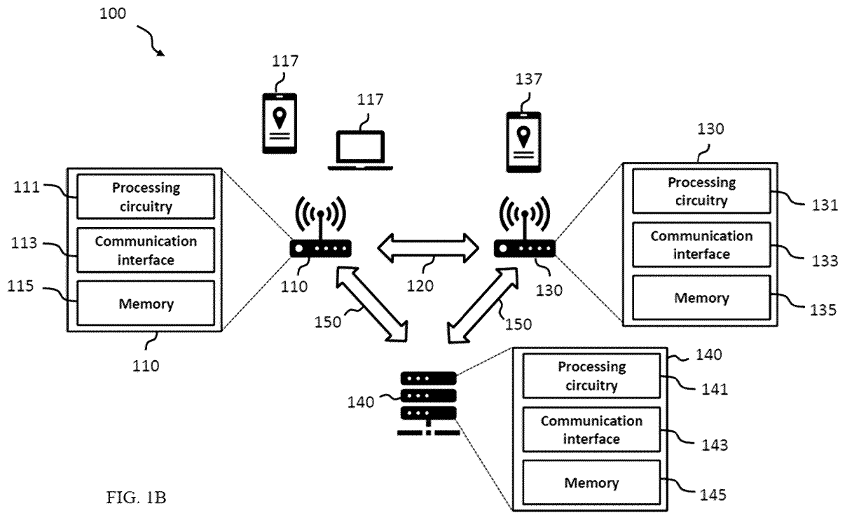

FIG. 1A shows an exemplary wireless communication network 100, in a particular local area network (WLAN 100) based on the IEEE 802.11 framework of standards. The wireless communication network 100 comprises an AP 110 associated, by way of example with two non-AP stations 117, which, as illustrated in FIG. 1A, may comprise a smartphone, laptop computer or another type of wireless communication device. By means of the association with the AP 110 the two non-AP stations 117 may communicate with further networks connected to the AP 110, in particular the Internet.

As illustrated in FIG. 1A, the AP 110 comprises a processing circuitry 111 and a communication interface 113, in particular a wireless communication interface 113, for example in accordance with the IEEE 802.11 framework of standards. The processing circuitry 111 may be implemented in hardware and/or software and may comprise digital circuitry, or both analog and digital circuitry. Digital circuitry may comprise components such as application-specific integrated circuits (ASICs), field-programmable arrays (FPGAs), digital signal processors (DSPs), or general-purpose processors. The AP 110 may further comprise a memory 115 configured to store executable program code which, when executed by the processing circuitry 111, causes the AP 110 to perform the functions and methods described herein.

Moreover, the wireless communication network 100 shown in FIG. 1A comprises at least one further AP 130 associated, by way of example with one non-AP station 137, which, as illustrated in FIG. 1A, may comprise a smartphone, laptop computer or another type of wireless communication device. By means of the association with the further AP 130 the non-AP station 137 may communicate with further networks connected to the further AP 130, in particular the Internet. As will be appreciated, the further AP 130 and its associated non-AP station 137 define an OBSS relative to the BSS defined by the AP 110 and its associated non-AP stations 117.

As illustrated in FIG. 1A, the further AP 130 may comprise a processing circuitry 131 and a communication interface 133, in particular a wireless communication interface 133, for example in accordance with the IEEE 802.11 framework of standards. The processing circuitry 131 may be implemented in hardware and/or software and may comprise digital circuitry, or both analog and digital circuitry. Digital circuitry may comprise components such as ASICs, FPGAs, DSPs, or general-purpose processors. The further AP 130 may further comprise a memory 135 configured to store executable program code which, when executed by the processing circuitry 131, causes the further AP 130 to perform the functions and methods described herein.

As illustrated in FIG. 1A, the AP 110 is configured to communicate with the at least one further OBSS AP 130 of the wireless communication network 100 via a communication channel 120, which may be a wired or a wireless communication channel 120, such as a wired backbone connection or the air interface.

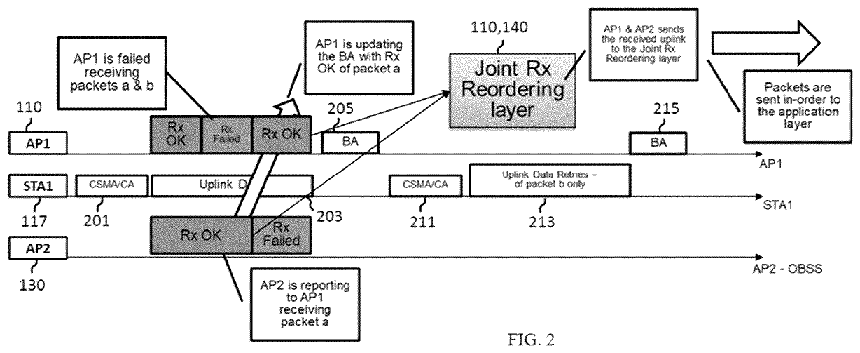

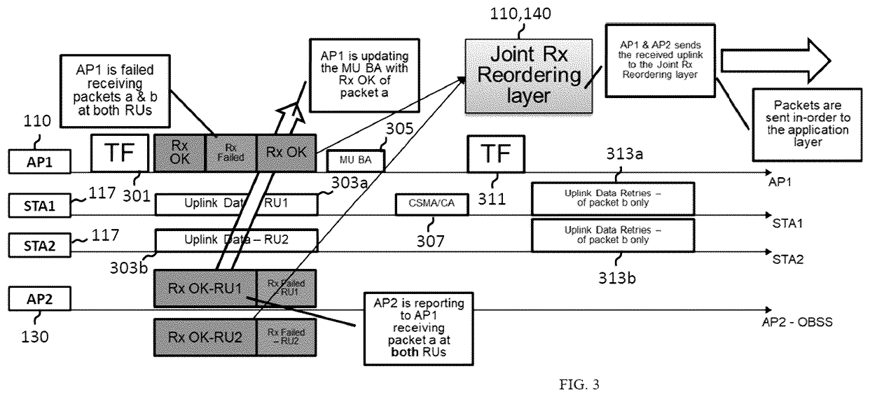

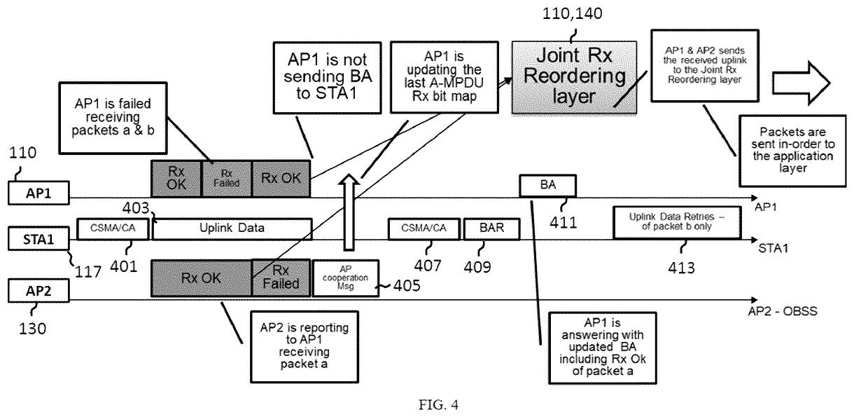

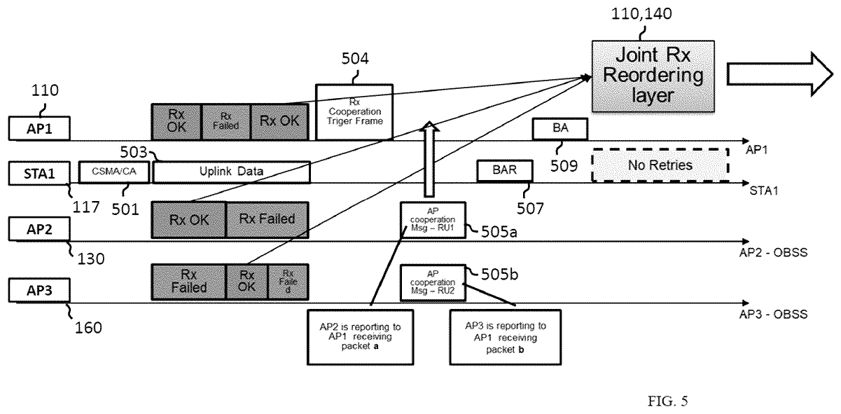

As will be described in more detail below under further reference to FIGS. 2 to 6, the communication interface 113 of the AP 110 (referred to as AP 1 in FIGS. 2 to 6) is configured to receive from one or more of its associated non-AP stations 117 a subset of a plurality of uplink packets transmitted by the non-AP station(s) 117 to the AP 110. In other words, in communication scenarios the communication interface 113 of the AP 110 may receive some, but not all of the uplink packets transmitted by the non-AP station(s) 117 to the AP 110. However, as will be described in more detail in the context of FIGS. 2 to 6, the communication interface 113 of the AP 110 is further configured to receive from the further OBSS AP 130 a further subset of the plurality of uplink packets transmitted by the one or more non-AP stations 117 to the AP 110. In other words, in communication scenarios the communication interface 133 of the further OBSS AP 130 may receive at least some of the uplink packets transmitted by the non-AP station(s) 117 and actually intended for the AP 110. The processing circuitry 111 of the AP is configured to determine, i.e. to reconstruct the plurality of uplink packets transmitted by the one or more associated non-AP stations 117 based on the subset and the further subset of the plurality of uplink packets transmitted by the one or more associated non-AP stations 117. Thus, as will be appreciated, the processing circuitry 110 of the AP 110 is configured to implement a kind of joint reception reordering layer that is configured to obtain the complete set of uplink packets transmitted by the one or more non-AP stations 117 based on the subset actually received by the AP 110 and the further subset received by the further OBSS AP 130.

In an embodiment, each uplink packet of the plurality of uplink packets comprises a packet sequence identifier and/or a traffic identifier and the processing circuitry 111 of the AP 110 is further configured to arrange the subset and the further subset of the plurality of uplink packets based on the packet sequence identifier and/or the traffic identifier of each uplink packet.

FIG. 1B shows another embodiment of the wireless communication network 100, which is a variant of the embodiment shown in FIG. 1A. In the embodiment shown in FIG. 1B the joint reception reordering layer that is configured to obtain the complete set of uplink packets transmitted by the one or more non-AP stations 117 to the AP 110 is implemented by a backend network device 140 that may be connected via a wired connection with the AP 110 and the further AP 130. Furthermore, in the embodiment shown in FIG. 1B, a communication interface 143 of the network entity 140 is configured to receive from the AP 110 the subset of a plurality of uplink packets transmitted by the one or more non-AP stations 117 to the AP 110. Moreover, the communication interface 143 of the network entity 140 is configured to receive from the further OBSS AP 130 the further subset of the plurality of uplink packets transmitted by the one or more non-AP stations 117 to the AP 110, but received by the further OBSS AP 130. A processing circuitry 141 of the network entity 140 is configured to implement the joint reception reordering layer, i.e. to determine the complete set of uplink packets transmitted by the one or more non-AP stations 117 based on the subset and the further subset of the plurality of uplink packets transmitted by the one or more non-AP stations 117.

The processing circuitry 141 of the network entity 140 may be implemented in hardware and/or software and may comprise digital circuitry, or both analog and digital circuitry. Digital circuitry may comprise components such as ASICs, FPGAs, DSPs, or general-purpose processors. The network entity 140 may further comprise a memory 145 configured to store executable program code which, when executed by the processing circuitry 141, causes the network entity 140 to perform the functions and methods described herein.

As already mentioned above, FIGS. 2 to 6 show timing diagrams illustrating the interaction between the AP 110, the further OBSS AP 130 and the network entity 140 in the wireless communication network 110 according to an embodiment for different communication scenarios. In the embodiments shown in FIGS. 2 to 6 the joint reception reordering layer for determining the complete set of uplink packets transmitted by the one or more non-AP stations 117 may be implemented by the AP 110 itself or the network entity 140.

The embodiment shown in FIG. 2 illustrates a single user reception, wherein the AP 110 (referred to as AP1 in FIG. 2) and the further OBSS AP 130 (referred to as AP2 in FIG. 2) cooperate via a wired connection 150. After the non-AP station 117 (referred to as STA1 in FIG. 2) has performed channel sensing 201, it transmits a plurality of uplink packets 203 to the AP 110. By way of example, the AP 110 may not receive a packet a and a packet b of these plurality of uplink packets. Packet a, however, may be received by the OBSS AP 130, which reports to the AP 110 that it has received packet a. In response thereto, the AP 110 will update a BA message 205 that also the packet a has been received (but not packet b). In response to receiving the BA message 205 the non-AP station 117 again performs channel sensing 211 and, if successful, retries to send the uplink packet b to the AP 110 (see 213), which again triggers a BA message 215 from the AP 110. As illustrated in FIG. 2 and described already above, the AP 110 and the OBSS AP 130 provide the respective received uplink packets to the joint reception reordering layer for determining the complete set of uplink packets transmitted by the non-AP station 117, which, as described above, may be implemented by the AP 110 itself or the network entity 140. The joint reception reordering layer implemented by the AP 110 or the network entity 140 may pass on the complete set of uplink packets to an application layer.

The embodiment shown in FIG. 3 illustrates a multi user reception, wherein the AP 110 and the further OBSS AP 130 again cooperate via the wired connection 150. In this case the AP 110 sends a trigger frame 301 to its associated non-AP stations 117 (referred to as STA1 and STA2 in FIG. 3). In response thereto, the non-AP stations 117 start transmitting the uplink packets 303a, 303b to the AP 110, wherein each non-AP station 117 may use its own resource units. By way of example, the AP 110 may not receive a packet a and a packet b of these plurality of uplink packets at both resource units used by the non-AP stations 117. Packet a, however, may be received by the OBSS AP 130 at both resource units, which reports to the AP 110 that it has received packet a. In response thereto, the AP 110 will update a multi user BA message 305 that also the packet a has been received (but not packet b). In response to receiving the multi user BA message 305 the non-AP stations 117 perform channel sensing 307. In response to receiving a further trigger frame 311 from the AP 110, each non-AP station 117 retries to send the uplink packet b to the AP 110 (see 313a, 313b). As illustrated in FIG. 3 and described already above, the AP 110 and the OBSS AP 130 provide the respective received uplink packets to the joint reception reordering layer for determining the complete set of uplink packets transmitted by the non-AP stations 117, which, as described above, may be implemented by the AP 110 itself or the network entity 140. The joint reception reordering layer implemented by the AP 110 or the network entity 140 may pass on the complete set of uplink packets to an application layer.

The embodiment shown in FIG. 4 illustrates a single user reception, wherein the AP 110 (referred to as AP1 in FIG. 4) and the further OBSS AP 130 (referred to as AP2 in FIG. 4) cooperate via the wireless connection 120. After the non-AP station 117 (referred to as STA1 in FIG. 4) has performed channel sensing 401, it transmits a plurality of uplink packets 403 to the AP 110. By way of example, the AP 110 may not receive a packet a and a packet b of these plurality of uplink packets. Packet a, however, may be received by the OBSS AP 130, which reports to the AP 110 by means of an AP cooperation message 405 that it has received packet a. In this embodiment (different to the embodiment in FIG. 2) the AP 110 will not send a BA message to the associated non-AP station 117 at this stage, but rather update a last aggregate MAC protocol data unit (A-MPDU) reception bit map. After performing channel sensing 407 again the non-AP station 117 sends a BA request (BAR) 409 to the AP 110. In response thereto, the AP 110 sends a BA message 411 to the non-AP station 117 informing the non-AP station about the uplink packets that have been received by the AP 110 or the OBSS AP 130. In response to receiving the BA message 411 the non-AP station 117 retries to send the uplink packet b to the AP 110 (see 413). As illustrated in FIG. 4 and described already above, the AP 110 and the OBSS AP 130 provide the respective received uplink packets to the joint reception reordering layer for determining the complete set of uplink packets transmitted by the non-AP station 117. The joint reception reordering layer implemented by the AP 110 or the network entity 140 may pass on the complete set of uplink packets to an application layer.

The embodiment shown in FIG. 5 illustrates a single user reception, wherein the AP 110 (referred to as AP1 in FIG. 5), the OBSS AP 130 (referred to as AP2 in FIG. 5) and a further OBSS AP 160 (referred to as AP3 in FIG. 5) cooperate via the wireless connection 120. After the non-AP station 117 (referred to as STA1 in FIG. 5) has performed channel sensing 501, it transmits a plurality of uplink packets 503 to the AP 110. By way of example, the AP 110 may not receive a packet a and a packet b of these plurality of uplink packets. Packet a, however, may be received by the OBSS AP 130, which reports to the AP 110 by means of an AP cooperation message 505a using a first set of resource units that it has received packet a. Moreover, packet b may be received by the further OBSS AP 160, which reports to the AP 110 by means of an AP cooperation message 505b using a second set of resource units that it has received packet b. As illustrated in FIG. 5, the AP cooperation messages 505a, 505b from the OBSS AP 130 and the further OBSS AP 160 may be triggered by a reception cooperation trigger frame 504 from the AP 110. The non-AP station 117 sends a BAR 507 to the AP 110. In response thereto, the AP 110 sends a BA message 509 to the non-AP station 117 informing the non-AP station 117 that the complete set of uplink packets has been received by the AP 110, the OBSS AP 130 or the further OBSS AP 160 so that in case no retries of uplink packet transmission by the non-AP station 117 are necessary. As illustrated in FIG. 5 and described already above, the AP 110, the OBSS AP 130 and the further OBSS AP 160 provide the respective received uplink packets to the joint reception reordering layer for determining the complete set of uplink packets transmitted by the non-AP station 117. The joint reception reordering layer implemented by the AP 110 or the network entity 140 may pass on the complete set of uplink packets to an application layer.

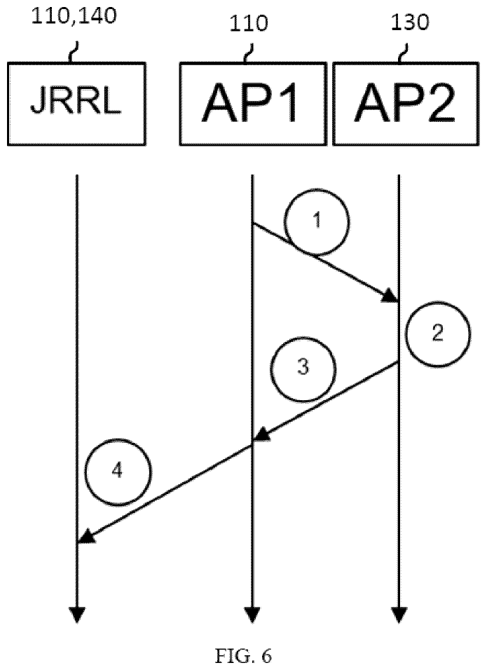

FIG. 6 shows a signalling diagram illustrating the interaction between the AP 110 and the OBSS AP 130 for commencing the advantageous cooperation described above in the wireless communication network 100 according to an embodiment, i.e. for grouping the AP 110 and the OBSS AP 130 for joint cooperation reception. In a first stage illustrated in FIG. 6, the AP 110 sends a grouping request to the OBSS AP 130. Such a request may be sent once, intermittently and/or at regular time intervals. In response to the grouping request the OBSS AP 130 in a second stage starts listening to the uplink traffic of the AP 110, i.e. to the uplink packets transmitted by the non-AP stations 117 to the AP 110. In a third stage the OBSS AP 130 sends a grouping request acknowledgment message to the AP 110, which may include a positive (or negative) response to the grouping request and information about the non-AP station(s) 137 associated with the OBSS AP 130, such as a Rx STA MAC Address, a Rx RSSI, and/or a Rx SNR. If in the third stage the OBSS AP 130 replies with a positive answer to the grouping request, the AP 110 forwards this information (as well as any further information included in the response from the OBSS AP 130) to the joint reception reordering layer, which may be implemented by the AP 110 itself or the network entity 140.

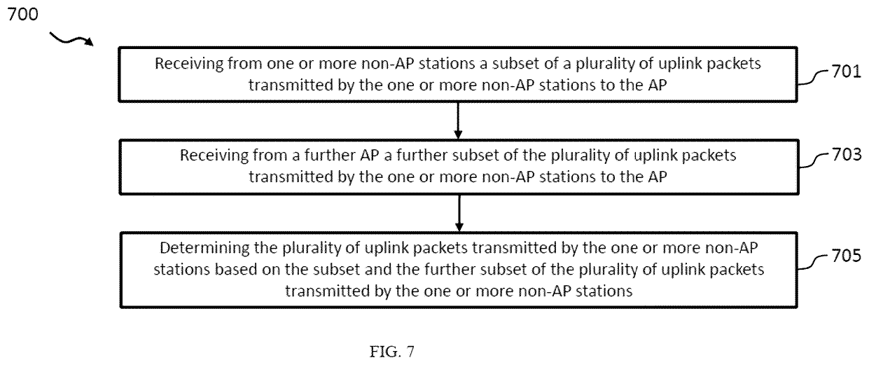

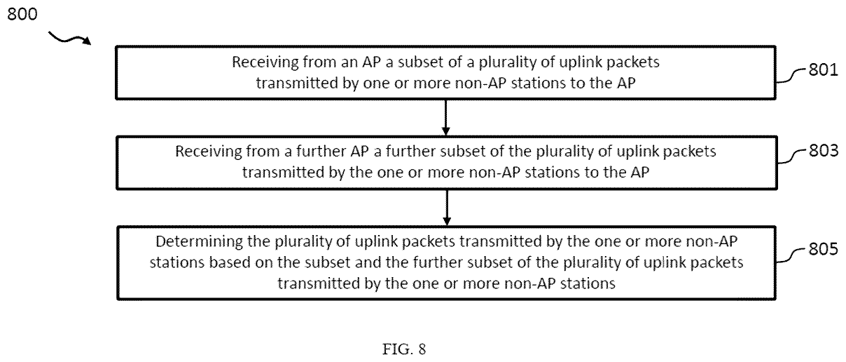

FIG. 7 shows a flow diagram illustrating processing steps of a method 700 implemented by the AP 110 according to an embodiment for operating the AP 110. The method 700 comprises a step 701 of receiving from the one or more non-AP stations 117 a subset of a plurality of uplink packets transmitted by the one or more non-AP stations 117 to the AP 110. Moreover, the method 700 comprises a step 703 of receiving from the further OBSS AP 130 a further subset of the plurality of uplink packets transmitted by the one or more non-AP stations 117 to the AP 110 and received by the further OBSS AP 130. The method 700 further comprises a step 705 of determining the plurality of uplink packets transmitted by the one or more non-AP stations 117 based on the subset and the further subset of the plurality of uplink packets transmitted by the one or more non-AP stations 117.

As the method 700 illustrated in FIG. 7 can be implemented by the AP 110, further features of the method 700 illustrated in FIG. 7 result directly from the functionality of the AP 110 and its different embodiments described above and below.

FIG. 8 shows a flow diagram illustrating processing steps of a method 800 implemented by the network entity 140. The method 800 comprises a step 801 of receiving from the AP a subset of a plurality of uplink packets transmitted by the one or more non-AP stations to the AP 110. Moreover, the method 800 comprises a step 803 of receiving from the further OBSS AP 130 a further subset of the plurality of uplink packets transmitted by the one or more non-AP stations 117 to the AP 110 and received by the further OBSS AP 130. The method 800 further comprises a step 805 of determining the plurality of uplink packets transmitted by the one or more non-AP stations 117 based on the subset and the further subset of the plurality of uplink packets transmitted by the one or more non-AP stations 117.

As the method 800 illustrated in FIG. 8 can be implemented by the network entity 140, further features of the method 800 illustrated in FIG. 8 result directly from the functionality of the network entity 140 and its different embodiments described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units are integrated into one unit.

What is claimed is:

1. A first access point (AP)comprising:
a communication interface configured to:
receive, from one or more non-AP stations, a first subset of a plurality of uplink packets; and
receive, from the a second AP, a second subset of the plurality of uplink packets; and
processing circuitry coupled to the communication interface and configured to determine, based on the first subset and the second subset, the plurality of uplink packets from the one or more non-AP stations .

2. The first AP of claim 1, wherein the communication interface is further configured to receive the second subset via a wired connection or a wireless connection with the second AP.

3. The first AP of claim 1, wherein the communication interface is further configured to send, to the one or more non-AP stations in response to receiving the second subset, a block acknowledgment (BA) message.

4. The first AP of claim 1, wherein the plurality of uplink packets comprise packet sequence identifiers or traffic identifiers, and wherein the processing circuitry is further configured to arrange, based on the packet sequence identifiers or the traffic identifiers, the first subset and the second subset.

5. The first AP of claim 1, wherein the communication interface is further configured to:
transmit, to the second AP, a grouping request; and
receive, from the second AP in response to the grouping request, a grouping acknowledgement message.

6. The first AP of claim 5, wherein the grouping acknowledgement message comprises one or more of a first address of each of the one or more non-AP stations, a second address of the second AP, a receiving received signal strength indicator (RSSI) of each of the one or more non-AP stations, or a receiving signal-to-noise ratio (SNR) of each of the one or more non-AP stations.

7. A method comprising:
receiving, by a first AP from one or more non-AP stations, a first subset of a plurality of uplink packets;
receiving, by the first AP from a second AP, a second subset of the plurality of uplink packets; and
determining, by the first AP based on the first subset and the second subset, the uplink packets from the one or more non-AP stations .

8. The method of claim 7, further comprising sending, to the one or more non-AP stations, a block acknowledgment (BA) message in response to receiving the second subset.

9. The method of claim 7, wherein the plurality of uplink packets comprise packet sequence identifiers, and wherein the method further comprises arranging, by the first AP and based on the packet sequence identifiers, the first subset and the second subset.

10. The method of claim 7, wherein each of the plurality of uplink packets comprise traffic identifiers, and wherein the method further comprises arranging, by the first AP and based on the traffic identifiers, the first subset and the second subset.

11. The method of claim 7, further comprising:
transmitting, by the first AP to the second AP, a grouping request; and
receiving, by the first AP from the second AP, a grouping acknowledgement message in response to the grouping request.

12. The method of claim 11, wherein the grouping acknowledgement message comprises one or more of a first address of each of one or more second non-AP stations or a second address of the second AP.

13. The method of claim 11, wherein the grouping acknowledgement message comprises one or more of a receiving received signal strength indicator (RSSI) of each of one or more second non-AP stations.

14. The method of claim 11, wherein the grouping acknowledgement message comprises one or more of a receiving signal-to-noise ratio (SNR) of each of one or more second non-AP stations.

15. A network entity comprising:
a communication interface configured to:
receive, from a first access point (AP) a first subset of a plurality of uplink packets of one or more non-AP stations; and
receive, from a second AP, a second subset of the plurality of uplink packets of the one or more non-AP stations; and
a processing circuitry coupled to the communication interface and configured to determine, based on the first subset and the second subset, the plurality of uplink packets from the one or more non-AP stations.

16. The network entity of claim 15, wherein the communication interface is further configured to receive the first subset or the second subset via a wired connection with the first AP and the second AP.

17. The network entity of claim 15, wherein the communication interface is further configured to receive the first subset or the second subset via a wireless connection with the first AP and the second AP.

18. The network entity of claim 15, wherein each of the plurality of uplink packets comprises a packet sequence identifier or a traffic identifier, and wherein the processing circuitry is further configured to arrange, based on the packet sequence identifier or the traffic identifier, the first subset and the second subset.

19. The network entity of claim 15, wherein the communication interface is further configured to receive, from the first AP, a grouping acknowledgement message indicating a grouping of the first AP with the second AP.

20. The network entity of claim 19, wherein the grouping acknowledgement message comprises an address of each of the one or more non-AP stations at the second AP, a receiving received signal strength indicator (RSSI) of each of the one or more non-AP stations, or a receiving signal-to-noise ratio (SNR) of each of the one or more non-AP stations.
